(19) United States
(12) Patent Application Publication
(10) Pub. No.: US 2007/0133367 A1
(43) Pub. Date: Jun. 14, 2007

(54) INFORMATION RECORDING DEVICE AND RELATED METHOD

(76) Inventors: Wei-Hsiang Tseng, Taipei City (TW); Hsin-Cheng Chen, Tainan Hsien (TW); Jin-Bin Yang, Changhua County (TW)

Correspondence Address: NORTH AMERICA INTELLECTUAL PROPERTY CORPORATION, P.O. BOX 506, MERRIFIELD, VA, 22116, US

(21) Appl. No.: 11/306,039

(22) Filed: Dec. 14, 2005

(51) Int. Cl. G11B 20/10

(52) U.S. Cl. 369/47.28

(57) ABSTRACT

An information recording device and a related method are disclosed. The information recording device and the related method are capable of adjusting a phase error between a first synchronization signal and a second synchronization signal, where the first synchronization signal is synchronous to a location on a recording medium, the second synchronization signal is synchronous to a data pattern to be written onto the recording medium, and the data pattern comprise a sync pattern and a non-sync pattern. The information recording device includes a phase detector for detecting the phase error between the first synchronization signal and the second synchronization signal; and a controller, electrically connected to the phase detector, for adjusting the length of the non-sync pattern of the data pattern according to the phase error, thereby making the second synchronization signal substantially synchronized with the first synchronization signal.

### BACKGROUND

The invention relates to an information recording device and a related method, and more particularly, to an information recording device and a related method capable of adjusting the phase error between two synchronization signals by adjusting the length of a data pattern comprising one of the synchronization signals.

For several years, optical disc drives have been considered standard equipment for personal computers. Generally, optical disc drives are utilized to record information onto optical discs or to read information stored on the optical discs. In the related arts, optical disc drives are designed to read or write data upon different kinds of optical discs, such as compact disc (CD) and digital versatile disc (DVD). In addition, except for some write once optical disc e.g. CD-R and DVD-R, the optical disc drives are capable of rewriting data onto certain optical discs e.g. CD-RW and DVD-RW.

To adequately manage data, the storage region of an optical disc is fragmented into many small frames. The optical disc also has a storage format that must be determined before the data is recorded onto an optical disc. An optical disc drive ascertains the storage format of the optical disc in advance of recording data onto the optical disc. For example, the storage format of CD references additional frame information, including minute, second, and frame number that uniquely distinguish each frame, and the additional frame information is known as Absolute Time in Pre-groove (ATIP). Besides, the additional frame information of the DVD+ is known as Address In Pre-groove (ADIP), which comprises 52 ADIP units corresponding to the physical address and other information. Since the storage formats of different kinds of optical disc are described in the related specifications, the detail description is omitted for the sake of brevity.

Since a series of data is recorded onto an optical disc as a plurality of data sets, it is an important issue to record a data set into an expected location of the data set. In detail, the optical disc recording device compares a phase of a synchronization signal “Async” (ATIP Synchronous) with a phase of a synchronization signal “Esync” (Encoder Subcode Synchronous). The synchronization signal “Async” is periodically added to absolute-location information (i.e., the ATIP signal) that indicates the absolute location on the optical disc. The synchronization signal “Esync” is periodically added to the data to be written onto the optical disc. If a phase error between the synchronization signal “Async” and the synchronization signal “Esync” is greater than a threshold value then the data recorded onto the disc might be damaged.

The U.S. Pat. No. 6,795,384 discloses a method for solving the problem mentioned above. The related art utilizes a phase adjusting unit to determine the phase error between the synchronization signals “Async” and “Esync” that allows the phase adjusting unit to control the rotational speed of the optical disc. Since the rotational speed of the optical disc changes, the scanning speed of the optical disc also changes which resulting in the acceleration or deceleration of the synchronization signal “Async”. Therefore, the phase error between the synchronization signals “Async” and “Esync” is eliminated accordingly. In the same manner, related art is capable of controlling the operation timing of a plurality of encoded data sets, so as to adjust the written speed of data patterns corresponding to the encoded data sets. Since either the written speed of the data patterns corresponding to the encoded data sets is adjusted or the rotational speed of the optical disc is adjusted, the phase error is eliminated accordingly.

Please refer to FIG. 1. FIG. 1 is a functional block diagram of an optical disc drive 100 according to the related art. The optical disc drive 100 comprises a pick-up head 3, a reproducing circuit 4, a decoder 5, a timing management unit 6, an encoder 7, a pick-up head driving unit 8, a buffer memory 9, a buffer management unit 10, a synchronization detecting unit 11, a phase adjusting unit 13, and a Voltage Control Oscillator (VCO) 14. The buffer memory 9 controlled by the buffer management unit 10 stores the data transmitted from a host device, and transmits a plurality of data sets to the encoder 7. The encoder 7 encodes the data sets and then outputs encoded data sets to the pick-up head driving unit 8 according to a clock signal generated by the VCO 14. Please note that the clock signal relates to the operation timing mentioned above. Finally, the encoded data sets are recorded onto an optical disc by the pick-up head 3. After an RF signal corresponding to the recorded encoded data sets is read back by the pick-up head 3, the reproducing circuit 4 determines the ATIP information according to the RF signal. Next, the synchronization detecting unit 11 determines the synchronization signal “Async” according to the ATIP information. Finally, the phase adjusting unit 13 generates a control signal by comparing the synchronization signal “Async” with the synchronization signal “Esync”, so as to control the VCO 14. After the clock signal generated by the VCO 14 is adjusted according to the control signal, the phase error between the synchronization signals “Async” and “Esync” is reduced.

However, the operation of adjusting the clock signal must be implemented carefully. Otherwise, the phase error between the synchronization signals “Async” and “Esync” may cause oscillation resulting in the serious faulty adjustment of the phase error.

### SUMMARY

It is therefore one of the objectives of the claimed invention to provide an information recording device and related method to more easily reduce the phase error.

According to the claimed invention, an information recording device capable of adjusting a phase error between a first synchronization signal and a second synchronization signal is disclosed, where the first synchronization signal is synchronous to a location on a recording medium, the second synchronization signal is synchronous to a data pattern to be written onto the recording medium, and the data pattern comprise a sync pattern and a non-sync pattern. The information recording device comprises: a phase detector for detecting the phase error between the first synchronization signal and the second synchronization signal; and a controller, electrically connected to the phase detector, for adjusting the length of the non-sync pattern of the data pattern according to the phase error, thereby making the second synchronization signal substantially synchronized with the first synchronization signal.

According to the claimed invention, an information recording method for adjusting a phase error between a first synchronization signal and a second synchronization signal is disclosed, where the first synchronization signal is synchronous to a location on a recording medium, the second synchronization signal is synchronous to a data pattern to be written onto the recording medium, and the data pattern comprise a sync pattern and a non-sync pattern. The information recording method comprises: detecting the phase error between the first synchronization signal and the second synchronization signal; and adjusting the length of the non-sync pattern of the data pattern according to the phase error, thereby making the second synchronization signal substantially synchronized with the first synchronization signal.

In other words, the information recording device robs or stuffs the length of a non-sync pattern of the data pattern rather than adjusting the rotational speed of the optical disc or adjusting the clock signal of the encoder. Since the adjusted data pattern comprises the second synchronization signal, the phase error between the first and second synchronization signals is reduced.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of an optical disc drive according to a related art.

FIG. 2 is a schematic diagram of an information recording device according to a preferred embodiment of the present invention.

FIG. 3 is a schematic diagram of the synchronization signals “Async”, “Esync”, and the phase error between “Async” and “Esync”.

FIG. 4 is a functional block diagram of the encoder shown in FIG. 2.

FIG. 5 is a schematic diagram of a data pattern to be recorded onto a DVD.

FIG. 6 is a schematic diagram of a data pattern to be recorded onto a Blu-ray Disc.

FIG. 7 is a schematic diagram of a data pattern to be recorded onto a Compact Disc.

FIG. 8 is a schematic diagram of a data pattern to be recorded onto an HD DVD.

### DETAILED DESCRIPTION

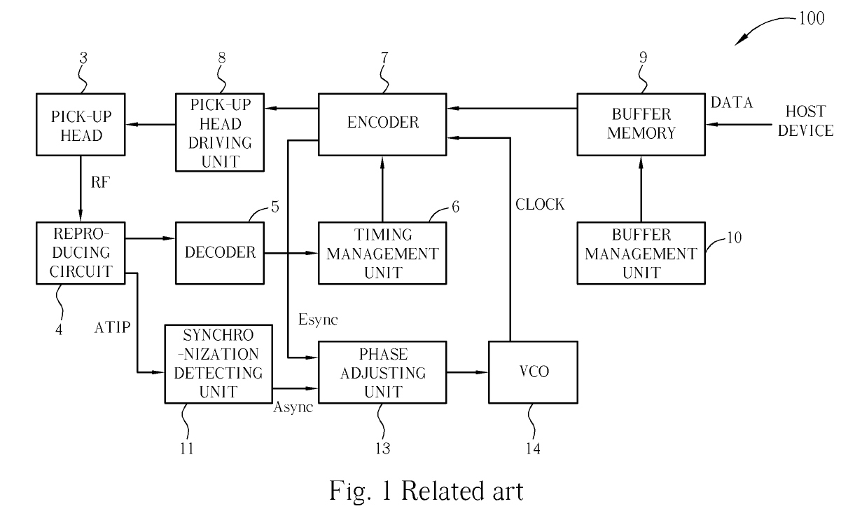

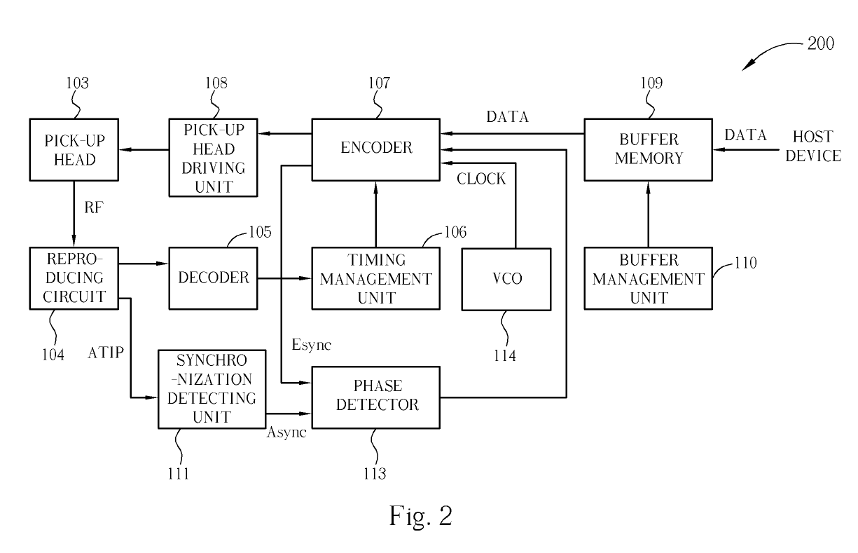

Please refer to FIG. 2. FIG. 2 is a schematic diagram of an information recording device 200 according to a preferred embodiment of the present invention. In the preferred embodiment, the information recording device 200 is an optical disc drive for reading or writing data onto DVD, CD, BD, or HD DVD. The information recording device 200 comprises a pick-up head 103, a reproducing circuit 104, a decoder 105, a timing management unit 106, an encoder 107, a pick-up head driving unit 108, a buffer memory 109, a buffer management unit 110, a synchronization detecting unit 111, a phase detector 113, and a Voltage Control Oscillator (VCO) 114. The operations and connection of the phase detector 113 and the encoder 107 are different between the information recording device 200 and the information recording device 100 shown in FIG. 1. The phase detector 113 determines the phase error between the synchronization signals “Async” and “Esync” and outputs a control signal to the encoder 107 when the phase error is greater than a threshold value. The encoder 107 is capable of adjusting the length of a data pattern according to the control signal and outputs the adjusted data pattern to the pick-up head driving unit 108.

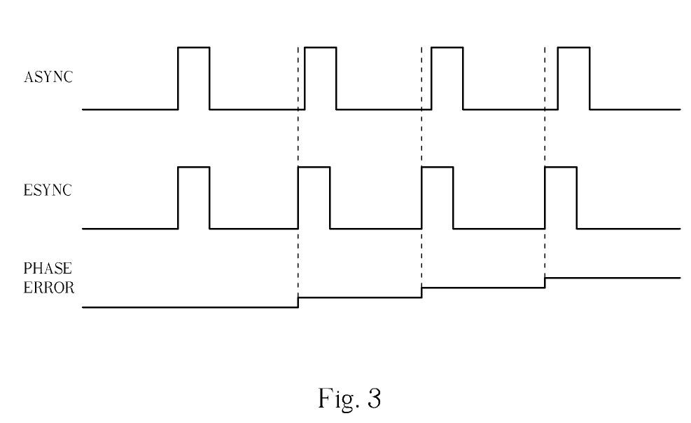

Please refer to FIG. 2 and FIG. 3. FIG. 3 is a schematic diagram of the synchronization signals “Async”, “Esync”, and the phase error between the “Async” and “Esync”. As shown in FIG. 3, the synchronization signal “Esync” leads the synchronization signal “Async” (i.e., the level transition of the synchronization signal “Esync” is earlier than the level transition of the synchronization signal “Async”). As a result, the phase error between the synchronization signals “Async” and “Esync” is positive and increases with time. If the phase error between the synchronization signals “Async” and “Esync” reaches a threshold value, the phase detector will transmit a control signal to the encoder 107, and let the encoder 107 extend the length of the data pattern to alleviate the phase error. In the same manner, if the synchronization signal “Async” leads the synchronization signal “Esync” and the phase error between the synchronization signals “Async” and “Esync” reaches a threshold value, the phase detector 113 will transmits a control signal to the encoder 107, and let the encoder 107 shorten the length of the data pattern to alleviate the phase error. Except for these differences in the encoder 107 as just described, the operations of the remaining components shown in FIG. 2 are similar to the operations of the components having the same name shown in FIG. 1. A detailed description of the other components is omitted for the sake of brevity.

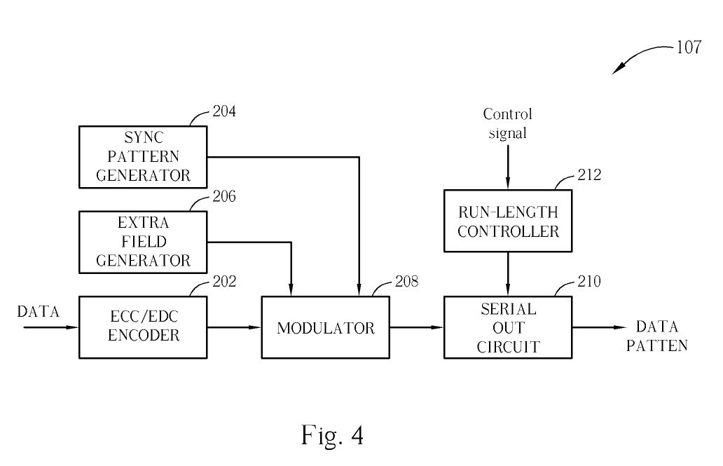

For explaining the operation of the encoder 107, please refer to FIG. 4. FIG. 4 is a functional block diagram of the encoder 107 shown in FIG. 2. According to the preferred embodiment, the encoder 107 comprises an ECC/EDC encoder 202, a sync pattern generator 204, an extra field generator 206, a modulator 208, a serial output circuit 210, and a run-length controller 212. The ECC/EDC encoder 202 utilizes the ECC (Error Correction Code) and EDC (Error Detection Code) algorithm to encode the data from the buffer memory 109 shown in FIG. 2 to generate an encoded data. Please note that the ECC and EDC algorithm varies with the type of the optical disc utilized for recording data. The sync pattern generator 204 and the extra field generator 206 generate patterns and data such as sync patterns, control data, and guard field patterns, for utilization by the modulator 208. Please note that the generated sync patterns, control data, and guard field patterns also vary with the type of the optical disc utilized for recording data. After the modulator 208 generates the data pattern according to the encoded data, the outputs of the sync pattern generator 204 and the extra field generator 206, the modulator 208 transmits the data pattern to the serial output circuit 210. Then the run-length controller 212 extends or shortens the length of the data pattern according to the control signal generated by the phase detector 113 shown in FIG. 2. Since the length of the data pattern, which comprises the synchronization signal “Esync”, is adjusted, the phase error between the synchronization signals “Async” and “Esync” is reduced accordingly.

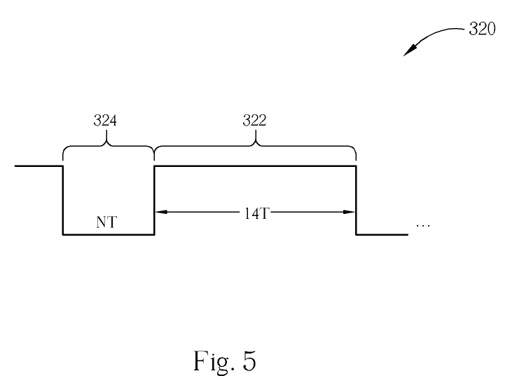

When different optical discs are utilized to record data, the operations of extending and shortening the data pattern to be written onto the optical disc will vary. Please refer to FIG. 5. FIG. 5 is a schematic diagram of a data pattern 320 to be recorded onto a DVD. As shown in FIG. 5, the data pattern 320 comprises a sync pattern 322 and a specific pattern 324. The specific pattern 324 is leading (i.e., before) and adjacent to the sync pattern 322 as shown in FIG. 5. The encoded run-length of the sync pattern 322 is 14T, and the encoded run-length of the specific pattern 324 is NT. According to the preferred embodiment, the encoded run-length of the specific pattern 324 can be extended to (N+1)T or shortened to (N−1)T, to reduce the phase error. It should be noted it is covered by the present invention to define the specific pattern 324 to be a sync_id.

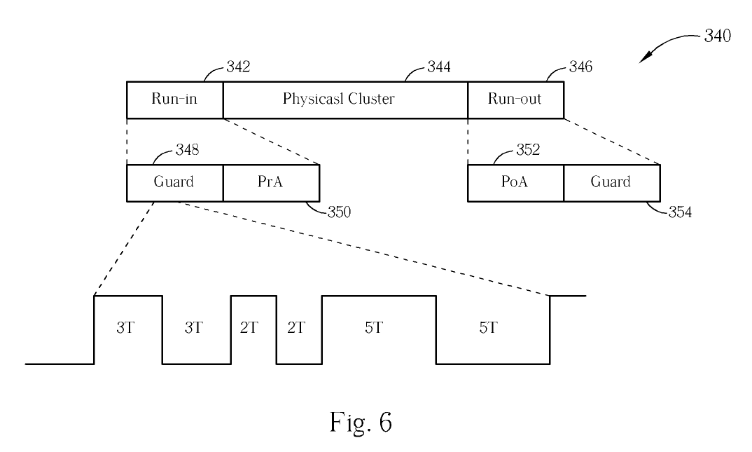

Please refer to FIG. 6. FIG. 6 is a schematic diagram of a data pattern 340 to be recorded onto a Blu-ray Disc (BD). As shown in FIG. 6, the data pattern 340 corresponds to a run-in area 342, a physical cluster 344, and a run-out area 346. The run-in area 342 comprises a guard field 348 and a preamble field 350. The run-out area 346 comprises a post-amble field 352 and a guard field 354. According to the preferred embodiment, the encoded run-length of any specific patterns in the guard fields 348 and 354, the preamble field 350, or the post-amble field 352 can be extended or shortened with 1T to reduce the phase error.

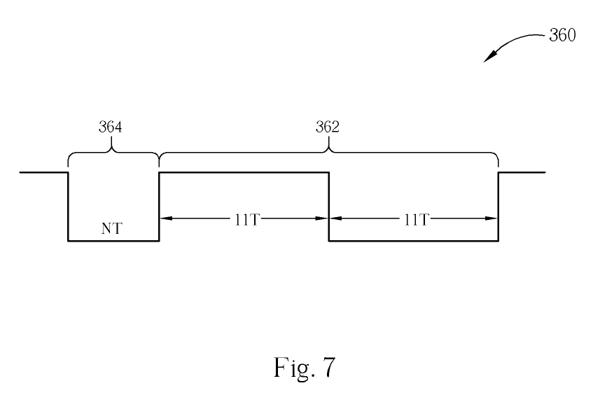

Please refer to FIG. 7. FIG. 7 is a schematic diagram of a data pattern 360 to be recorded onto a Compact Disc (CD). As shown in FIG. 7, the data pattern 360 comprises a sync pattern 362 and a specific pattern 364 leading and adjacent to the sync pattern. The specific pattern 364 corresponds to merging bits. The encoded run-length corresponding to the specific pattern is NT. The encoded run-length of the sync pattern 362 is 11T−11T. The encoded run-length of the specific pattern can be extended to (N+1)T or shortened to (N−1)T to reduce the phase error according to the preferred embodiment.

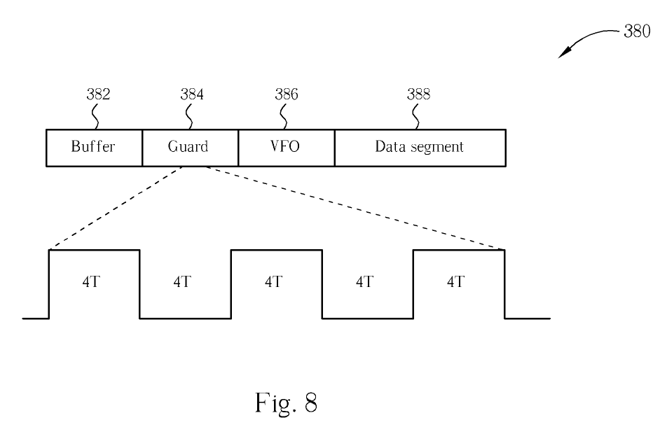

Please refer to FIG. 8. FIG. 8 is a schematic diagram of a data pattern 380 to be recorded onto an HD DVD. Similar to the data pattern 340, the data pattern 380 corresponds to a buffer field 382, a guard field 384, a Variable-Frequency Oscillator (VFO) field 386, and a data segment 388. According to the preferred embodiment, the encoded run-length of any specific patterns in the buffer field 382, the guard field 384, or the VFO field 386 can be extended or shortened with 1T to reduce the phase error. It should be noted the pattern adjusted by the run-length controller 212 is not limited to the specific patterns mentioned above. Except for the sync patterns, the run-length controller 212 is capable of adjusting the encoded run-length of any other patterns to eliminate the phase error according to the present invention. Please note that the adjusting range of the non-sync patterns is not limited to +1T˜−1T according to the present invention. In other words, the encoder applied in the present invention is capable of adjusting the length of the non-sync pattern with a greater range.

In summary, when the phase error between the synchronization signals “Esync” and “Async” reaches a threshold value, the information recording device robs or stuffs the encoded run-length of a non-sync pattern to reduce the phase error rather than adjusting the rotational speed of the optical disc or adjusting the clock signal of the encoder. Since the synchronization signal “Esync” is shifted after the encoded run-length of the non-sync pattern is adjusted, the phase error is reduced. Therefore, the method provided by the present invention more easily and steadily reduce the phase error than the method provided by the related art.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An information recording device capable of adjusting a phase error between a first synchronization signal synchronous to a location on a recording medium and a second synchronization signal synchronous to a data pattern to be written onto the recording medium, wherein the data pattern comprise a sync pattern and a non-sync pattern, the information recording device comprising:
a phase detector for detecting the phase error between the first synchronization signal and the second synchronization signal; and
a controller, electrically connected to the phase detector, for adjusting the length of the non-sync pattern of the data pattern according to the phase error, thereby making the second synchronization signal substantially synchronized with the first synchronization signal.

2. The information recording device of claim 1, wherein if the second synchronization signal leads the first synchronization signal, the controller extends the non-sync pattern of the data pattern according to the phase error; otherwise, the controller shortens the non-sync pattern of the data pattern according to the phase error.

3. The information recording device of claim 1, wherein the recording medium is a Compact Disc (CD), the data pattern comprises a first pattern corresponding to merging bits and a second pattern corresponding to a sync pattern, and the controller adjusts the run-length of the first pattern according to the phase error.

4. The information recording device of claim 1, wherein the recording medium is a Blu-ray Disc (BD), the data pattern comprises a specific pattern corresponding to a guard field, a preamble field, or a post-amble field, and the controller adjusts the length of the specific pattern according to the phase error.

5. The information recording device of claim 1, wherein the recording medium is a Digital Versatile Disc (DVD), the data pattern comprises a first pattern corresponding to a sync pattern and a second pattern leading and next to the sync pattern, and the controller adjusts the length of the second pattern according to the phase error.

6. The information recording device of claim 5, wherein the second pattern reltates to a sync_id.

7. The information recording device of claim 1, wherein the optical disc is a High Density Digital Versatile Disc (HD DVD), the data pattern comprises a specific pattern corresponding to a guard field, a buffer field, or a Variable Frequency Oscillator (VFO) field, and the controller adjusts the length of the specific pattern according to the phase error.

8. An information recording method capable of adjusting a phase error between a first synchronization signal synchronous to a location on a recording medium and a second synchronization signal synchronous to a data pattern to be written onto the recording medium, wherein the data pattern comprise a sync pattern and a non-sync pattern, the information recording method comprising:
detecting the phase error between the first synchronization signal and the second synchronization signal; and
adjusting the length of the non-sync pattern of the data pattern according to the phase error, thereby making the second synchronization signal substantially synchronized with the first synchronization signal.

9. The information recording method of claim 8, wherein the step of adjusting the length of the data pattern comprises:
if the second synchronization signal leads the first synchronization signal, extending the non-sync pattern of the data pattern according to the phase error; otherwise, shortening the non-sync pattern of the data pattern according to the phase error.

10. The information recording method of claim 8, wherein the recording medium is a Compact Disc (CD), the data pattern comprises a first pattern corresponding to merging bits and a second pattern corresponding to a sync pattern, and the step of adjusting the length of the data pattern comprises:
adjusting the length of the first pattern according to the phase error.

11. The information recording method of claim 8, wherein the recording medium is a Blu-ray Disc (BD), the data pattern comprises a specific pattern corresponding to a guard field, a preamble field, or a post-amble field, and the step of adjusting the length of the data pattern comprises:
adjusting the length of the specific pattern according to the phase error.

12. The information recording method of claim 8, wherein the recording medium is a Digital Versatile Disc (DVD), the data pattern comprises a first pattern corresponding to a sync pattern and a second pattern leading and next to the sync pattern, and step of adjusting the length of the data pattern comprises:
adjusting the length of the second pattern according to the phase error.

13. The information recording device of claim 12, wherein the second pattern relates to a sync_id.

14. The information recording method of claim 8, wherein the optical disc is a High Density Digital Versatile Disc (HD DVD), the data pattern comprises a specific pattern corresponding to a guard field, a buffer field, or a Variable Frequency Oscillator (VFO), and the step of adjusting the length of the data pattern comprises:
adjusting the length of the specific pattern according to the phase error.
